(19) United States
(12) Patent Application Publication
(10) Pub. No.: US 2026/0284575 A1
(43) Pub. Date: Sep. 24, 2026

(54) ADSORPTION DRYER

(71) Applicant: KAESER KOMPRESSOREN SE, Coburg (DE)

(72) Inventors: Markus KRAUS, Coburg (DE); Andreas FREDENHAGEN, Coburg (DE)

(21) Appl. No.: 19/469,863

(22) PCT Filed: Mar. 27, 2024
(86) PCT No.: PCT/EP2024/058386

§ 371 Date: Sep. 26, 2025

(30) Foreign Application Priority Data
Mar. 30, 2023 (DE) 10 2023 108 231.0

(51) Int. Cl. B01D 53/053; B01D 53/26

(52) U.S. Cl. CPC B01D 53/053; B01D 53/261; B01D 2257/80; B01D 2259/40054; B01D 2259/40092

(57) ABSTRACT

A method for drying a compressed gas, more particularly compressed air, using an adsorption dryer comprising at least one pressure vessel containing an adsorption material for adsorbing moisture from the compressed gas, wherein, in a drying mode for drying the compressed gas, the compressed gas flows from a drying inlet through a drying zone to a drying outlet, passing through the pressure vessel along the adsorption material, and exits as a dried compressed gas, wherein, in a regeneration mode for regenerating the adsorption material, a regeneration gas flows from the drying outlet through the drying zone to the drying inlet, passing through the pressure vessel along the adsorption material, and in doing so draws moisture out of the adsorption material, and in regeneration mode there is partial heating in a heating region in the pressure vessel, wherein the heating region is arranged only in a subregion of the pressure vessel adjoining the drying inlet.

The present invention relates to a process for drying a compressed gas and to an adsorption dryer.

Adsorption dryers are known and are used inter alia for drying compressed air or for drying another gas. All designs for drying compressed air can also be used for drying another gas.

For drying compressed air, adsorption methods are commonly used in which the compressed air flow is contacted with a solid adsorption material. The adsorption material takes up part of the water vapor present in the compressed air flow, thereby drying the compressed air. This increases the amount of water that is bound (adsorbed) in the adsorption material. When the adsorption material has taken up so much water that this prevents further compressed air from drying sufficiently, at least some of the water it contains must first be removed from the adsorption material before the adsorption material can be used further for drying compressed air. The removal of water from the desiccant is referred to as regeneration of the adsorption material. For the technical realization of a continuous drying operation, two or more vessels are typically provided, so that, when the adsorption material in one vessel is being regenerated, another previously regenerated vessel is always available for drying.

A well-known method of regeneration is to depressurize a portion of the previously dried compressed air to a low pressure and to pass it through the vessel containing the adsorption material that is to be regenerated. The flow direction here is usually opposite to the flow direction when drying compressed air. Dryers operated with this method are known as cold-regenerating adsorption dryers.

The partial pressure of the water vapor in an air flow can attain at most the vapor pressure of water. This limits the partial density of the water vapor in the air. The compressed air to be dried is generally 100% saturated with water vapor, i.e. the vapor pressure of water and hence the maximum possible partial densities are reached. At approximately constant temperature during drying and regeneration, the volume of the regeneration air must therefore be at least as large as the volume of the previously dried compressed air. The proportion of the compressed air that needs to be depressurized must therefore at approximately constant temperature be at least as high as the ratio of the pressures during regeneration and drying. This is because, at approximately constant temperature, the density is for ideal gases proportional to the pressure.

The disadvantage of this process is that this considerable proportion of the compressed air that is depressurized for regeneration is no longer available for further use and must therefore be compressed in addition to the amount of compressed air that is actually needed. This makes said process very energy-intensive.

Another well-known method of regeneration is to carry out regeneration at elevated temperature. The higher the temperature, the higher the vapor pressure of water. Regeneration is carried out here using heated ambient air. The chosen temperature during regeneration is high enough that the vapor pressure of water is sufficiently far above the partial pressure of the water vapor contained in the ambient air. This means that regeneration is possible despite the water vapor naturally already present in the ambient air. Dryers operated with this method are known as heat-regenerating adsorption dryers.

In this method, sufficient heat needs to be introduced via the heated ambient air that the dry material is heated to a high temperature, e.g. 150° C., and the water is desorbed from the dry material. Desorbed means that the water passes from the bound (adsorbed) state into the gaseous state. The necessary heat energy in this method is less than the energy required to produce the compressed air that is depressurized for the regeneration in the method described above.

The disadvantage is that, at the end of regeneration, the dry material has a high temperature. This means that, immediately after switching a vessel over, the compressed air will be flowing through hot dry material. This heats up the compressed air to undesirable high temperatures and also dries it less well because, the hotter the dry material is, the less moisture it is able to remove from the compressed air.

To reduce these disadvantages, the dry material is cooled before it is used again for drying compressed air. The dry material can be cooled using ambient air and/or depressurized compressed air. Cooling with ambient air is limited by the fact that the dry material already takes up water vapor from the ambient air through the cooling process and is accordingly able to dry less compressed air. Cooling with depressurized compressed air is moreover possible only to a very limited degree when an energetic advantage is to be achieved compared to the method in which depressurized compressed air is used for regeneration.

The disadvantage of the high temperature and residual moisture immediately after switching a vessel to drying compressed air can thus only be reduced somewhat, but not averted.

U.S. Pat. No. 5,087,178 A describes a drying process in which, as in the case of a cold-regenerating adsorption dryer, regeneration is carried out using depressurized compressed air. Before the compressed air is depressurized, it is heated by oil from a screw compressor with oil injection. The heat introduced improves desorption. However, the heat input is limited by the heat capacity of the regeneration air. A considerable proportion of the compressed air is accordingly still needed for regeneration. The disadvantage here too is that the desiccant is heated up after regeneration and this residual heat results, as already described, in a significant increase in temperature and residual moisture after switching over to drying.

A similar drying process is also described in U.S. Pat. No. 4,898,599 A. To improve regeneration, the respective vessel is however here directly heated during regeneration by hot oil from a screw compressor with oil injection. As an alternative to the use of depressurized compressed air for regeneration, the removal of water vapor by aspiration is proposed. However, at the low water vapor pressures the vessel would in this case have to be evacuated to a very low pressure.

An advantage over U.S. Pat. No. 5,087,178 A is that the heat input can be effected independently of the regeneration air. The disadvantage of high residual heat is however likewise an issue with U.S. Pat. No. 4,898,599 A.

In EP 1 010 452 B 1 too, at least a portion of the dry material is heated independently of the compressed air by a resistance or microwave heater. Here, the heating of the dry material is realized by two or more independently activatable heating devices, which allows the heating of the dry material in the upper portion of the vessel to be stopped even when the heating in the lower portion of the vessel is still active. This makes it possible to achieve a certain reduction in the amount of compressed air needed for cooling. However, a large amount of cooling air is still required to cool the entire contents of the vessel. An adsorption buffer is described in U.S. Pat. No. 3,204,388 A. A vacuum regeneration is described in KR 101214541 B1.

The object of the present invention is thus to address at least one of the problems mentioned above. In particular, a method is to be developed that has the lowest possible energy requirement and has fewer high temperatures and moistures in the compressed air after switching a regenerated vessel over to drying compressed air. The intention is at least to propose an alternative solution to solutions known to date.

The invention also proposes a process as claimed in claim 1. The process thus relates to the drying of a compressed gas, in particular compressed air, using an adsorption dryer. Such an adsorption dryer includes at least one pressure vessel containing an adsorption material for adsorbing moisture from the compressed gas. Such an adsorption material can be a suitable granulate that is arranged in the pressure vessel and passed through by the compressed air during operation.

The process is operated in such a way that, in a drying mode for drying the compressed gas, the compressed gas flows from a drying inlet through a drying zone to a drying outlet, passing through the pressure vessel along the adsorption material, and exits as a dried compressed gas. The compressed gas thus flows through the pressure vessel along the adsorption material, which may be present in the form of granules, thereby releasing moisture onto this adsorption material. The dried compressed gas thus has less moisture than it did before flowing along the adsorption material immediately after entry through the drying inlet.

Particularly for structural reasons and/or for functional tasks, the pressure vessel may not be completely filled with adsorption material. In that case, it has a transition region in each case up to the adsorption material in the region of the drying inlet and/or the drying outlet, in which there is thus no adsorption material. Each transition region may occupy about 2%-10% of a length from the drying inlet to the drying outlet. A drying zone refers to a zone in the adsorption material, i.e. a zone from the drying inlet to the drying outlet, minus the at least one transition region.

In a regeneration mode for regenerating the adsorption material, a regeneration gas flows from the drying outlet through the drying zone to the drying inlet, passing through the pressure vessel along the adsorption material, and in doing so draws moisture out of the adsorption material. Thus, in regeneration mode, the flow direction is reversed relative to drying mode, with the result that the regeneration gas flows in the opposite direction to the compressed gas to be dried and in doing so draws moisture back out of the adsorption material that the adsorption material had taken up from the compressed gas to be dried.

It is additionally proposed that in regeneration mode there is partial heating in a heating region in the pressure vessel. The pressure vessel is thus heated in regeneration mode, but not throughout the vessel. The heating region is here arranged only in a subregion of the pressure vessel adjoining the drying inlet. The regeneration gas thus flows first through an unheated region in the pressure vessel and then through the heating region.

The heating heats the regeneration gas, thereby increasing its water vapor uptake capacity. This makes it able to take up more water. The adsorption material, which is likewise heated by this, is likewise able to release its moisture more readily.

However, it has been recognized that the compressed air to be dried releases the most moisture in the region where it flows in, i.e. close to the drying inlet. The adsorption material thus essentially has the greatest moisture content close to the drying inlet, which decreases toward the drying outlet. It is precisely this finding that is made use of by the proposed process. Thus, in regeneration mode the regeneration gas flows first into the region of the pressure vessel in which the adsorption material has taken up comparatively little moisture. Moreover, the regeneration gas is then itself still very dry at first, i.e. it has not yet itself taken up any or much moisture. This comparatively dry regeneration gas is thus able to take up the little moisture in the adsorption material in the region of this drying outlet fairly readily.

In this regard, the amount of moisture taken up by the regeneration gas increases from the drying outlet to the drying inlet. Toward the drying inlet, from which the regeneration gas will flow out, it will thus have taken up a lot of moisture, but will still have a great deal more moisture yet to take up from the adsorption material, since the adsorption material has a lot of moisture close to the drying inlet.

Therefore, in this region close to the drying inlet the pressure vessel is heated. The regeneration gas, more particularly air, is also heated up by this and is able to take up more moisture, since its water vapor uptake capacity increases as a result of the heating.

It is however proposed that this heating is to take place only in a subregion of the pressure vessel. Heating is provided only where the increase in water vapor uptake capacity is needed. This was recognized to be in the region of the drying inlet, as described above.

It has also been recognized that it is particularly advantageous that the drying air flows in one direction, whereas the regeneration gas flows in the opposite direction. The flow direction of the compressed gas to be dried results in a corresponding gradient in the moisture taken up in the pressure vessel, the throughflow of the regeneration gas in the opposite direction being well matched to this, particularly through the selective heating of the regeneration gas prior to its exit.

An improvement in the process compared to the prior art is thus achieved by the fact that there is only a selective heat input, where it is needed to improve efficiency. When the pressure inlet is at the bottom of the vessel, most of the water vapor will during drying already be adsorbed in the lower portion of the pressure vessel. The selective heat input in this lower portion of the vessel that is passed through by the regeneration air immediately before exiting the vessel means that the water vapor uptake capacity of the regeneration air is increased only from the point at which a higher capacity is necessary, since it is only there that a lot of water can be released into the air. This avoids heating up too much dry material unnecessarily.

In one aspect it is proposed that the heating region is arranged in a section of from 0% to 80%, preferably 0% to 60%, and in particular 0% to 50%, of the drying zone. The heating region is therefore provided in the region around the drying inlet.

It is in addition or alternatively proposed that the heating region extends over at least 20% of the drying zone, preferably over at least 30% of the drying zone, in particular over at least 40% of the drying zone. In particular, there is no heating outside the heating region, or at most reduced heating with less than 30% energy input per unit volume compared to the heating region.

It has been recognized that it is particularly advantageous to heat about half the drying zone, specifically the half toward the drying inlet. The heating region is therefore located close to the drying inlet. It is in a section from 0% to 80% and therefore anyhow not in the section from 80% to 100%. This section can remain free and does not need to be heated, for the reasons explained above. It has however been recognized that it may be sufficient to provide heating in the region from 0% to 60%. 0% to 50% is particularly favorable, since this allows about half of the drying zone to be heated. The pressure vessel can be positioned vertically, for example, so that the drying inlet is at the bottom and the drying outlet is at the top. In such an essentially cylindrical vessel, the adsorption material or a frame that accommodates the adsorption material can be adjusted within the pressure vessel, for example on feet, so that the adsorption material, and hence the start of the drying zone, is at a distance of about 5% from the drying inlet.

It is in addition or alternatively proposed that the heating region extends over at least 30% of the drying zone, in particular over at least 40% of the drying zone, it being preferably arranged in said section from 0% to 80%, 0% to 60% or 5% to 50%. This allows a significant region of the drying zone, specifically at least 30%, to be heated. A higher regeneration effect can be achieved by a larger region of at least 40%, but this can result in a higher energy input. The heating region should not extend over the entire drying zone and should therefore preferably extend over at most 70%, in particular at most 60%, of the drying zone.

Outside the heating region there should be no heating. Thus, no heating takes place outside the heating region throughout the regeneration mode. It may in principle be possible for there to be a reduced heating with less than 30% energy input per unit volume compared to the heating region. The energy input per unit volume can however be even less than 10% compared to the heating region. Heating outside the heating region is not generally envisaged, but if there is heating there for other reasons, which could possibly be envisaged for the drying mode, this cannot be ruled out and results merely in an undesired energy input, which is as far as possible to be avoided.

In one aspect it is proposed that a compressed gas fraction, i.e. some of the dried compressed gas, is used as regeneration gas, that the compressed gas fraction is admitted into the pressure vessel at the drying outlet, and that the compressed gas fraction undergoes a reduction in pressure during or before admission into the pressure vessel.

This allows a portion of the dried compressed gas to be used to regenerate, i.e. to dry, the adsorption material. One practical option for implementation is in particular to use two pressure vessels that are operated alternately in drying mode or in regeneration mode. When a pressure vessel is operating in drying mode, it continuously outputs dried compressed air and this can be used in the other vessel operating in regeneration mode for regeneration, i.e. for drying the adsorption material. In order that this dried compressed gas, i.e. more particularly the dried compressed air, is able to take up more moisture from the adsorption material, even in the unheated region, it undergoes a reduction in pressure. The compressed gas is thus itself dried at higher pressure and the reduction in pressure allows it essentially to readsorb its own moisture from the adsorption material.

Once this compressed gas fraction has been used for regeneration, it can be discharged as wet gas/wet compressed air, optionally no longer under pressure or under an overpressure, or some of its moisture can be released again in a water separator. Such a water separator can operate for example by condensation.

In one aspect it is proposed that the heating in the pressure vessel is effected by means of a heat exchanger, wherein heat transfer sections of the heat exchanger are surrounded by the adsorption material so as to release heat to the adsorption material. However, in regeneration mode the heat exchanger also transfers heat directly to the regeneration gas, i.e. more particularly the regeneration air.

It has been recognized here that the use of a heat exchanger allows heat arising elsewhere in the system to be used to heat the pressure vessel. The heat exchanger here comprises heat transfer sections that are arranged in the pressure vessel. These heat transfer sections are designed such that they are surrounded by adsorption material in the pressure vessel. In particular, the adsorption material is provided in the form of granules and thus in the form of a bulk material. The heat transfer sections are designed and then arranged in the pressure vessel such that such a granular bulk material is able to surround said heat transfer sections. In particular, it may be poured or is poured between subsections of the heat transfer sections.

The heat transfer sections may for this purpose be designed for example as sections that are a cylindrical disk shape or circular in shape or as a plurality of flat sections arranged parallel to one another and designed such that the granules can be poured around them; in the case of sections arranged parallel to one another, these are sufficiently far apart that the granules can be poured therebetween.

Here it was in particular recognized that the regeneration gas can be heated directly or indirectly, namely directly by the regeneration gas also flowing past these heat transfer sections. It can be heated indirectly by the adsorption material surrounding the heat transfer sections being able to be heated and the regeneration gas then being heated by the adsorption material as the gas flows past or through said material.

In one aspect it is proposed that the compressed gas is generated by a pressure generating device, in particular a compressor, and waste heat of the pressure generating device is used for heating the heating region during regeneration. In particular, it is proposed that heated oil from a screw compressor with oil injection is used to heat the heating region during regeneration.

Here it was in particular recognized that the generation of the pressure of the compressed gas generates a great deal of heat, which in the regeneration can now be put to good use for heating purposes. The use of a small heating region that heats only a portion of the drying zone also increases the suitability of such a heating region; such waste heat of a pressure generating device or compressor can be used for heating and on top of this to introduce sufficient heat energy. This makes it possible to efficiently design a compressed air system that comprises the adsorption dryer and also the pressure generating device.

As a result of its function, the use of a screw compressor with oil injection causes oil to be heated and this oil can be used for heating by means of the heat exchanger; more particularly it can be used as a liquid heat-transfer medium in such a heat exchanger. The term heat-transfer medium can also be referred to synonymously as heating medium.

In one aspect it is proposed that the heating region is heated using waste heat of the pressure generating device and active heating from an energy source, in particular such that the active heating further raises a temperature of a heating medium heated from the waste heat to a predetermined temperature.

The heating of the heating region can thus then use waste heat of the pressure generating device, in particular of the screw compressor, even when this waste heat is not on its own sufficient for heating. Active heating can be supplemented by further heating the heating medium that had been heated by the waste heat of the pressure generating device, by active heating. For example, the oil of an oil-injecting screw compressor may have a temperature of 60 to 100° C. If the temperature is for example 60° C., however, a temperature of 100° C. in the heat exchanger, more particularly in the heat transfer section of the heat exchanger, is advisable; this allows the oil at the exemplary 60° C. to be increased by 40K to 100° C. and then used accordingly in the heat exchanger.

It is particularly advantageous in all aspects that use the heated oil of the oil-injecting screw compressor that they allow the screw compressor to be cooled at the same time. This of course applies only if the active additional heating of the heated oil does not introduce more energy than is released again in the heating region.

In one aspect it is proposed that at least two pressure vessels be used. In a combined operation, at least one of the pressure vessels operates in drying mode while another operates in regeneration mode. The pressure vessel operating in drying mode outputs dried compressed gas, a portion of which is diverted as a compressed gas fraction and supplied to the pressure vessel operating in regeneration mode and thereby used as regeneration gas.

More particularly, exactly two pressure vessels are used, which can essentially operate in alternating mode so that one operates in drying mode and the other in regeneration mode.

The pressure vessel operating in drying mode then not only supplies the required compressed gas, more particularly the required compressed air, but in addition also supplies the regeneration gas, i.e. regeneration air in the case of compressed air. The advantages described above that have been described for the use of the compressed gas fraction for regeneration are as a result readily implementable.

The combined operation thus describes the situation in which the drying mode and the regeneration mode operate in parallel. There may however also be situations in which only the drying mode is in operation.

However, it should be noted that the drying mode and regeneration mode do not necessarily have to be permanently in operation at the same time; rather, it may for example be the case that the regeneration and thus the regeneration mode have already ended, whereas the drying mode is being continued for a while. The drying mode then produces exclusively dried compressed gas, which is accessed without any of it being diverted for regeneration.

The drying mode is more particularly continued for as long as the adsorption material in the pressure vessel operating in drying mode is still able to take up sufficient moisture. As soon as the adsorption material is no longer able to take up sufficient moisture, optionally a little earlier, the vessels can be switched over so that the pressure vessel that had been operating in drying mode is now being operated in regeneration mode. The pressure vessel that had been operating in regeneration mode is then operated in drying mode.

The principle has been described on the basis of two pressure vessels able to operate in alternating mode. However, it is also possible for more pressure vessels to be provided. In particular, it is possible for there to always be in each case a plurality of pressure vessels being operated in drying mode and a plurality in regeneration mode. Whether two or more pressure vessels are being used may also be a question of the size of the pressure vessels employed as standard, together with the question of what volume of pressure gas is to be dried per unit time. When more than two pressure vessels are being used, it is also possible that at least one is being operated in drying mode, at least one is being operated in regeneration mode, and at least one is in standby mode.

In one aspect it is proposed that when switching over from drying mode to regeneration mode the flow of the compressed gas from the drying inlet to the drying outlet is initially paused, then the heating of the heating region is started and, after starting heating, a pre-determined heating time is observed before admitting the regeneration gas into the vessel. This ensures that the adsorption material in the heating region is initially heated and only then is the regeneration gas admitted, so that the regeneration gas flows through a heated heating region from the outset and can accordingly have an increased water vapor uptake capacity in the heating region from the outset.

This prevents regeneration gas from being wasted/not being fully utilized to begin with. Particularly when combined with heating by waste heat, it has also been recognized that early heating of the heating region before regeneration gas flows through does not result in any energy loss or any appreciable energy loss. It has also been recognized that the adsorption material can have a high heat capacity and therefore that early heating essentially results only in the heat energy being stored and not being released unused.

It has also been recognized that during operation of the adsorption device there is sufficient time available for regeneration. Particularly in the advantageous alternating mode in which at least two vessels switch between drying mode and regeneration mode, there is sufficient time available for the regeneration mode.

The predeterminable heating time can be calculated depending on the heat capacity of the adsorption material in the heating region and the amount of heat, i.e. heat energy, introduced per unit time. In this case, an adsorption device is designed such that the heat introduced and the heat capacity of the adsorption material in the heating region are matched to one another. The heating time will then be within a range from 3 min to 25 min.

In one aspect it is proposed that, when switching over from regeneration mode to drying mode, the heating is initially stopped and, after stopping heating, a predeterminable cooling time is observed before admitting the compressed gas into the pressure vessel. In particular, it is the case that, after stopping heating, regeneration gas continues to flow through the pressure vessel for part or all of the cooling time.

Stopping heating before compressed gas is admitted for drying in drying mode achieves cooling of the pressure vessel, in particular cooling of the adsorption material in the region of the heating region, but also of other elements in the heating region. This prevents the compressed gas that is to be dried from being heated in the heating region, thereby increasing its water vapor uptake capacity and thus releasing less moisture. There would thus be a risk that the compressed gas to be dried will not be sufficiently dried.

Cooling can in particular be promoted by the regeneration gas continuing to flow through the pressure vessel, and thus also flowing through the heating region, after stopping heating. This regeneration gas is thus able to cool the heating region. Ideally, this takes place over the entire cooling time, but can for technical reasons also be for a somewhat shorter period.

Particularly in alternating mode, in which at least two pressure vessels alternate between drying mode and regeneration mode, the drying mode can be continued in the at least one pressure vessel while the other pressure vessel is being prepared for the drying mode. The preparation is effected specifically by the aforementioned stopping of heating while continuing the throughflow of the regeneration gas. This regeneration gas, which then continues to flow through the pressure vessel during the cooling time, can thus continue to be supplied by the pressure vessel that is still operating in drying mode.

It is also possible for the pressure vessel operating in drying mode to switch to a standby mode. In this standby mode, the flow through the pressure vessel of the compressed gas that is to be dried is paused, especially if no compressed gas is required at that moment. There is also then no flow of any other gas through the pressure vessel. A distinction must be made between this standby mode and the cooling phase after stopping heating and before the actual drying mode commences with the admission of the compressed gas to be dried. In the cooling phase it is specifically the case that regeneration gas flows through the pressure vessel.

The cooling time can be calculated as a function of the mass of regeneration gas flowing through relative to the mass of the heated adsorption material that is now to be cooled. The adsorption material can moreover also be referred to as desiccant. It has been recognized that the ratio of the mass of the regeneration gas to the mass of the heated adsorbent for cooling is in the range from 0.025 kg/kg to 0.22 kg/kg. The cooling time can thus be the time that the corresponding mass of regeneration gas needs in order to flow through the compressed gas vessel.

The cooling time therefore also depends on the flow velocity, i.e. on the mass of regeneration gas flowing through the pressure vessel per unit time. This flow rate and mass of the heated adsorption material that is to be cooled back down are generally matched to one another. This results in a predeterminable cooling time in the range from about 1 to 30 min.

In one aspect it is proposed that compressed air is dried as the compressed gas and that a portion of the dried compressed air is used for the regeneration gas, so that regeneration air is used as the regeneration gas, wherein after flowing through the drying zone the regeneration air flows out into an environment of the adsorption dryer.

The proposed process can thus be used in particular for drying compressed air. This also has the advantage that ambient air can be used, which is changed into compressed air through compression and is then dried. A portion of the dried compressed air can then be used again for regeneration and can be discharged back into the atmosphere without any problems. This makes it possible to dispense with further drying of the moisture-enriched regeneration air.

In one aspect it is proposed that in regeneration mode a pressure in the pressure vessel is lowered to below a pressure outside the pressure vessel, in particular to below atmospheric pressure. This also lowers the pressure of the regeneration gas being admitted into said pressure vessel. This regeneration gas is consequently able to take up more moisture, thereby allowing the drying process of the adsorption material, i.e. the regeneration of the adsorption material, to be enhanced compared to a scenario with higher pressure.

There may be a special compressor present that achieves this low pressure, which can also be referred to as a negative pressure. One option for implementation is for the regeneration gas to be admitted as regeneration air and driven out of the pressure vessel by a compressor that lowers the pressure in the pressure vessel, in particular into the environment when the regeneration gas is air.

In one aspect it is proposed that dried compressed air after flowing out of the drying outlet flows through an auxiliary pressure vessel containing an adsorption material, the auxiliary pressure vessel not being integrated into the regeneration mode.

It has been recognized that switching between drying mode and regeneration mode can result in a fluctuation in the degree of drying of the dried compressed air, which is reflected in a pressure dew point of the dried compressed air. This pressure dew point may be elevated in particular after switching over from regeneration mode to drying mode. The compressed air is then wetter than desired and can therefore release moisture more readily.

Specifically, it is proposed that said auxiliary pressure vessel is provided for this purpose, in which moisture can be released to the adsorption material at this elevated pressure dew point. This adsorption material does not however need to be dried again by a separate operation. Rather, the dried compressed air is able to take up moisture from the adsorption material of this further pressure vessel itself once its pressure dew point has gone back down. The auxiliary pressure vessel is therefore not subject to the switching between drying mode and regeneration mode.

A measure of the proportion of water vapor in the compressed air is the pressure dew point, i.e. the temperature at which the partial pressure of the water vapor in the compressed air at operating pressure is exactly equal to the vapor pressure of water.

Despite the improvements achieved, the proposed process for adsorption drying in accordance with the proposed adsorption dryer also results in certain increases in the pressure dew point after switching a vessel over from regeneration to drying.

The maximum pressure dew point may therefore be above an average pressure dew point even in the case of the proposed solution. It has moreover been recognized that the maximum pressure dew point can be an important criterion and that a solution for lowering the maximum pressure dew point has been found here. In particular, this needed to be achieved without significantly increasing the energy requirement, as would have been necessary for a lowering of the average pressure dew point. It needed to be achieved at least without increasing the heat output, without increasing the amount of regeneration air, and without shortening the drying times.

As a solution, it is proposed that dried compressed air after flowing out of the drying outlet flows through the auxiliary pressure vessel containing the adsorption material. Thus, it is proposed that the dried compressed air flows through an adsorption buffer. This adsorption buffer is the vessel, specifically the auxiliary pressure vessel, filled with dry material.

A temporary increase in the residual moisture content of the compressed air results in said dry material initially taking up a major part of the additional water, resulting in a significant reduction in the pressure dew point at the outlet of the adsorption buffer relative to that at the inlet. When the compressed air subsequently returns to a lower pressure dew point, the dry material releases the additional water again. Over a longer period of time this leads to a slight elevation in the pressure dew point during throughflow of the adsorption buffer.

Viewed over the entire operating time of the adsorption buffer, the amount of water vapor in the compressed air is not reduced, but the maximum pressure dew point is significantly lowered. This lowering is achieved in a very energy-efficient manner, since only the energy required to overcome the low flow resistance of the adsorption buffer is necessary for operation.

Also proposed in accordance with the invention is an adsorption dryer. Thus, an adsorption dryer is proposed for drying a compressed gas, more particularly compressed air, the adsorption dryer comprising at least one pressure vessel containing an adsorption material for adsorbing moisture from the compressed gas, said dryer being primed to carry out a process in which
in a drying mode for drying the compressed gas, the compressed gas flows from a drying inlet through a drying zone to a drying outlet, passing through the pressure vessel along the adsorption material, and exits as a dried compressed gas,
in a regeneration mode for regenerating the adsorption material, a regeneration gas flows from the drying outlet through the drying zone to the drying inlet, passing through the pressure vessel along the adsorption material, and in doing so draws moisture out of the adsorption material, and
in regeneration mode there is partial heating in a heating region in the pressure vessel,
the heating region is arranged only in a subregion of the pressure vessel adjoining the drying inlet.

In particular, it is proposed that the adsorption dryer is designed to carry out a process in accordance with any of the aspects or embodiments described above. The adsorption dryer is preferably in addition connected in a corresponding manner such that the compressed gas and the regeneration gas can correspondingly flow through the pressure vessels and can correspondingly also be passed through appropriate interconnections. A corresponding control device may be provided for control purposes that in particular starts, controls, and stops the drying mode and the regeneration mode. An appropriate heating device is provided for heating. The adsorption dryer is moreover additionally connected to a pressure generating device, in particular a compressor, and to a conduit system for receiving and/or distributing the compressed gas.

The operation and advantages of such an adsorption dryer arise from the explanations described for the process for drying a compressed gas.

In one aspect it is proposed for the adsorption dryer that
the heating region is arranged in a section of from 0% to 80%, preferably 0% to 60%, and in particular 0% to 50%, of the drying zone, measured from the drying inlet to the drying outlet,
and extends over at least 20% of the drying zone, preferably over at least 30% of the drying zone, and in particular over at least 40% of the drying zone, preferably over at most 70%, in particular at most 60%, of the drying zone, and/or that
a heat exchanger is provided for heating in the pressure vessel that
comprises heat transfer sections arranged in the heating region that are surrounded by the adsorption material.

A heating region is thus proposed that is provided specifically where the regeneration of the adsorption material will as a result be improved.

In one aspect it is proposed for the adsorption dryer that
at least two pressure vessels are provided and that
the adsorption dryer is primed for a combined operation in which at least one of the pressure vessels operates in drying mode while another operates in regeneration mode, wherein
the pressure vessels are connected with one another such that their combined effect is that the pressure vessel operating in drying mode outputs dried compressed gas, a portion of which is diverted as a compressed gas fraction and supplied to the pressure vessel operating in regeneration mode and used as regeneration gas, and/or that
an auxiliary pressure vessel containing an adsorption material is provided, the auxiliary pressure vessel being connected to the other pressure vessels such that it is not integrated into the regeneration mode.

Thus, an adsorption dryer is in particular provided in which a plurality of pressure vessels are able to alternate between a drying mode and a regeneration mode. The pressure vessel operating in drying mode is here able to release regeneration gas for the other pressure vessel operating in regeneration mode. The pressure vessels are in addition connected to one another in a corresponding manner such that corresponding pressure gas is able to flow from one pressure vessel to another and also such that this can be selectively controlled by appropriate valves.

The auxiliary vessel may be arranged in particular such that a diverted portion of the dried compressed gas from the one pressure vessel is provided for use as regeneration gas in the other pressure vessel at a point upstream of the auxiliary pressure vessel relative to a direction of flow of the dried compressed gas. The auxiliary pressure vessel containing its adsorption material can in particular be designed to be completely passive, i.e. the auxiliary pressure vessel is not actively subjected to a change in pressure, nor is it heated or cooled.

Further aspects have been described in connection with the drying process to which reference is made here.

The invention also proposes a compressed gas system for providing dried compressed gas. Thus, a compressed gas system is proposed that comprises
a pressure generating device, in particular a compressor, for compressing gas into compressed gas,
an adsorption dryer comprising a plurality of pressure vessels filled with an adsorption material, the pressure vessels each having
   a drying zone for drying the compressed gas, and
   a heating region that extends only over a portion of the drying zone, wherein a heat exchanger is provided that, for the heating of the heating region, is connected to the compressor so as to heat the heating region with waste heat from the compressor.

Preferably, this compressed gas system comprises an adsorption dryer according to one of the aspects described above. The compressed gas system accordingly benefits from the advantages already described above for the adsorption dryer or for the drying process.

It is particularly advantageous that the use of the waste heat of the compressor for heating in the heating region of the adsorption dryer allows a synergy effect to be achieved in which the waste heat of the compressor can be advantageously used in the adsorption dryer.

The invention will now be more particularly elucidated by way of example below on the basis of embodiments and with reference to the accompanying figures.

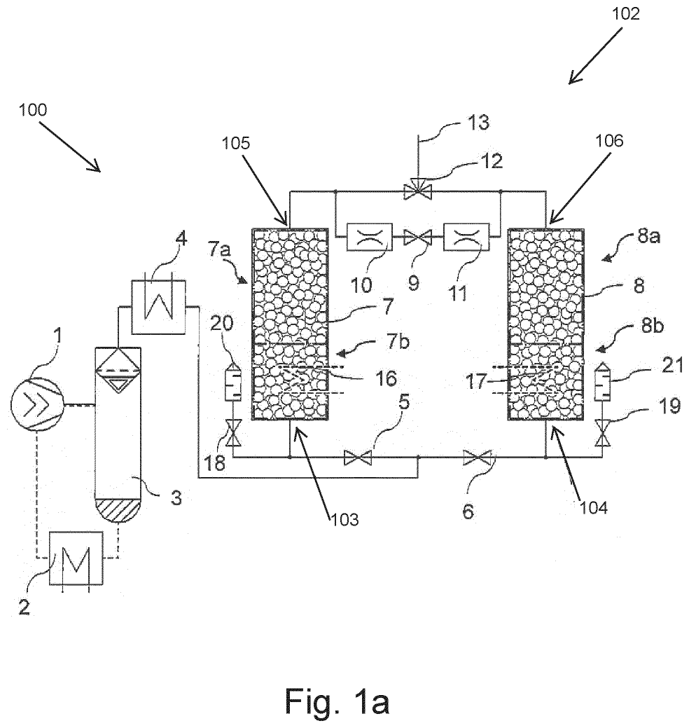

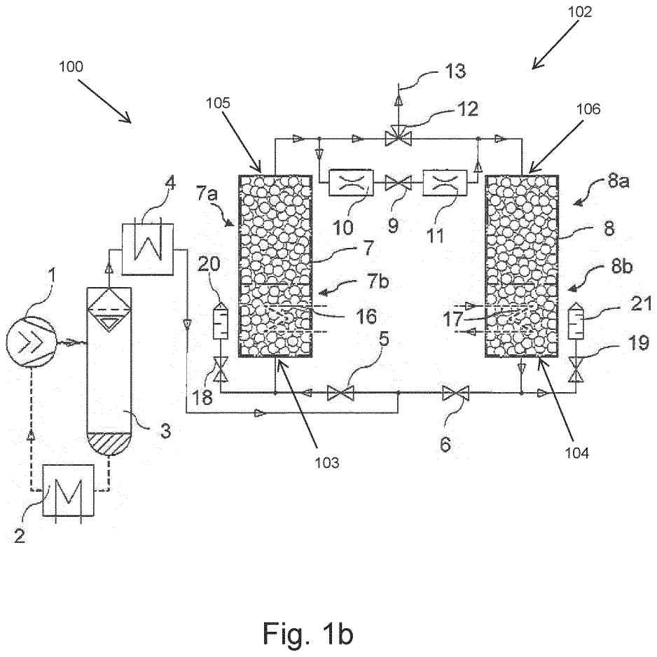

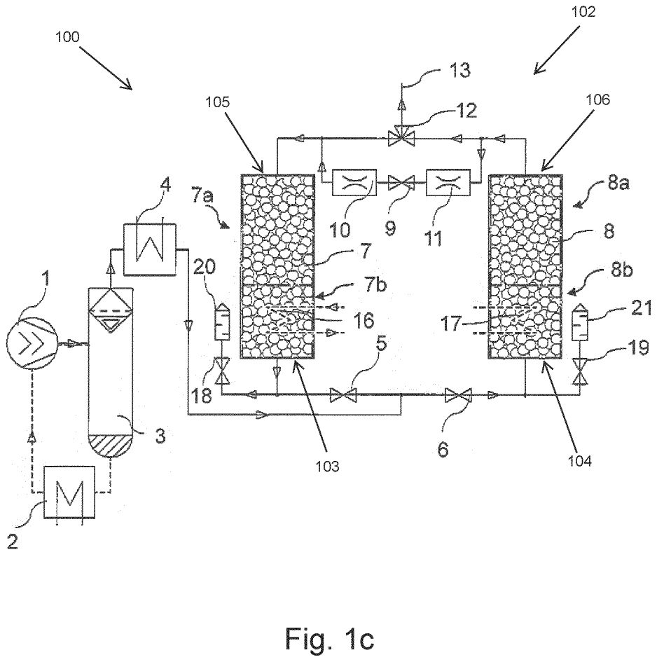

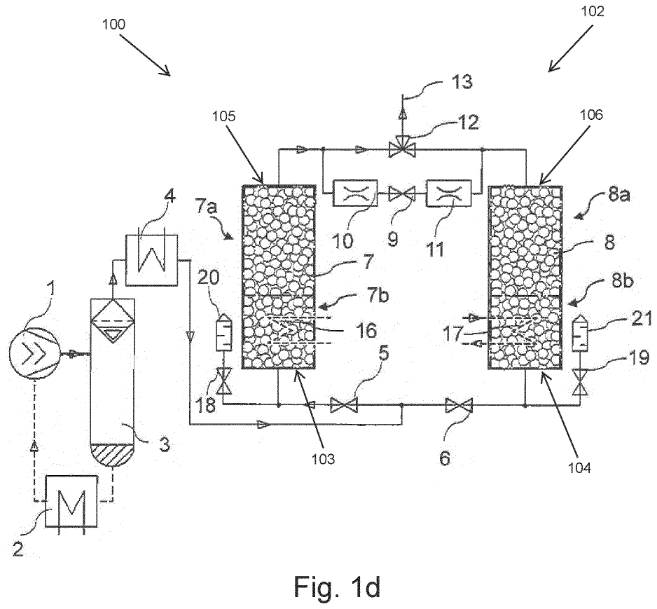

FIGS. 1a to 1e show a compressed gas system comprising an adsorption dryer for different process steps.

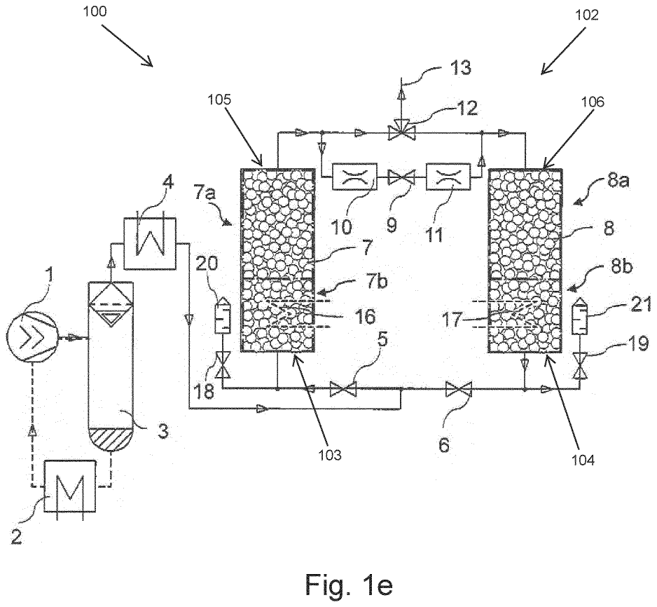

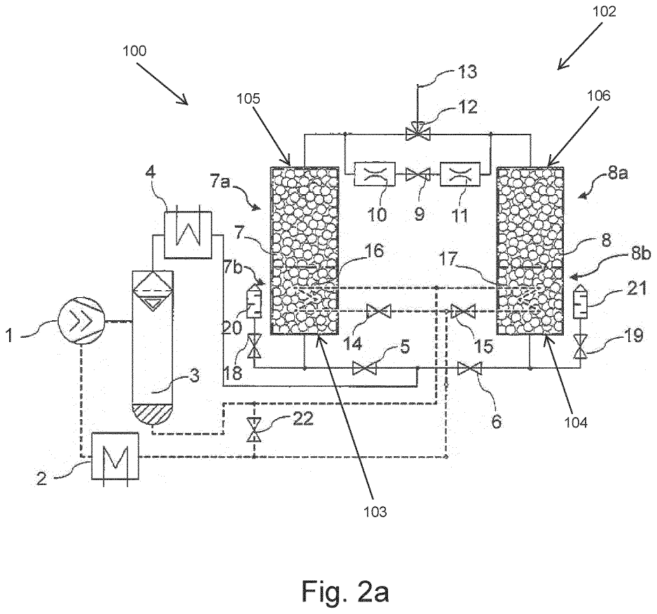

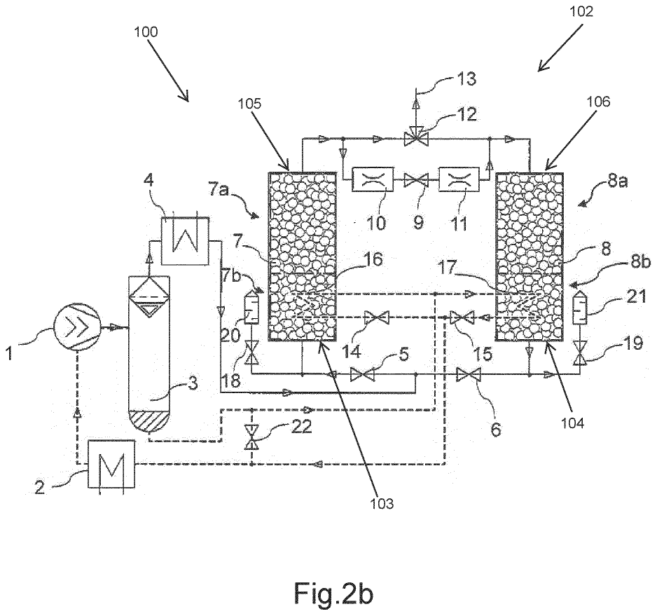

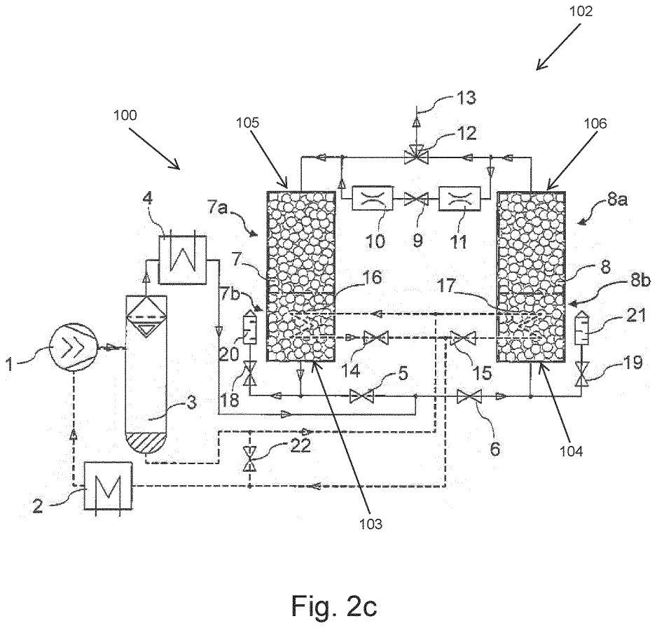

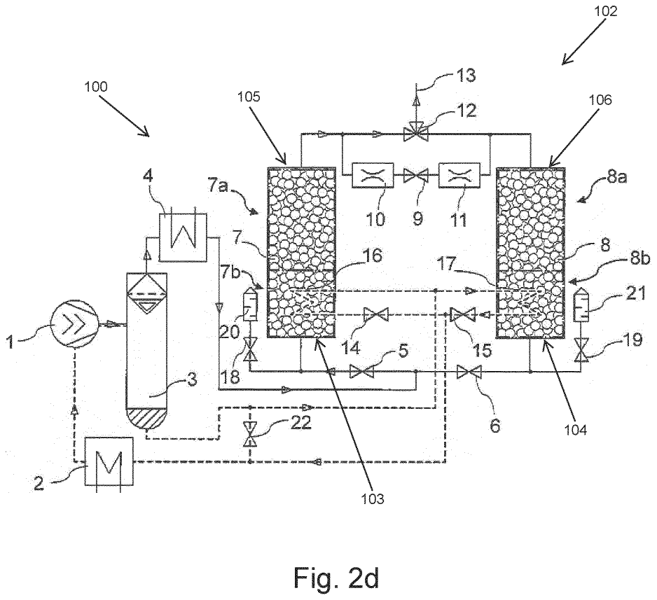

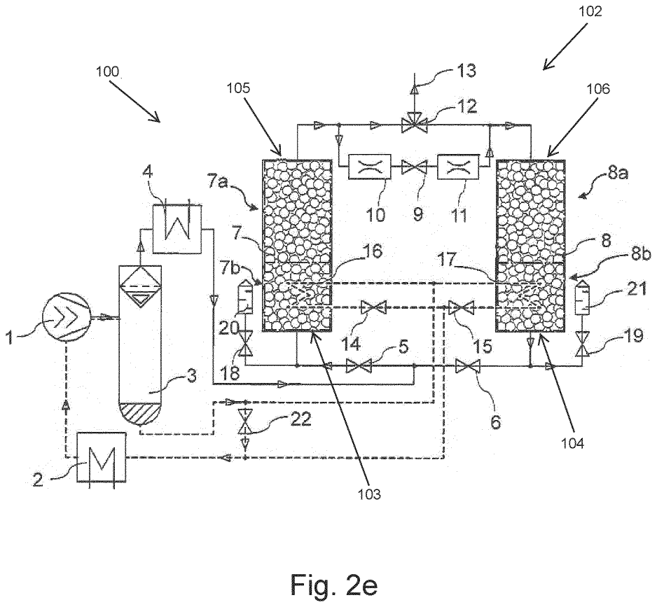

FIGS. 2a to 2e show a compressed gas system comprising an adsorption dryer for different process steps according to a further embodiment.

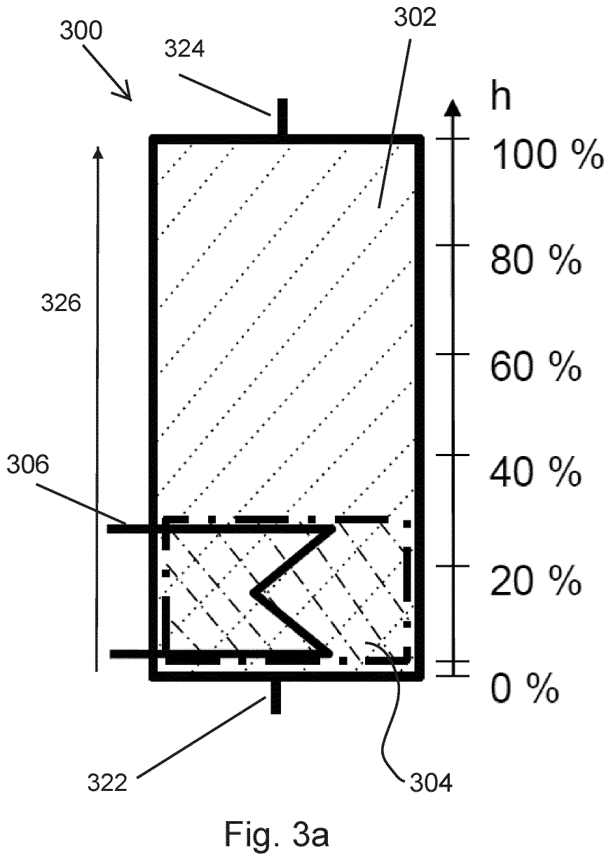

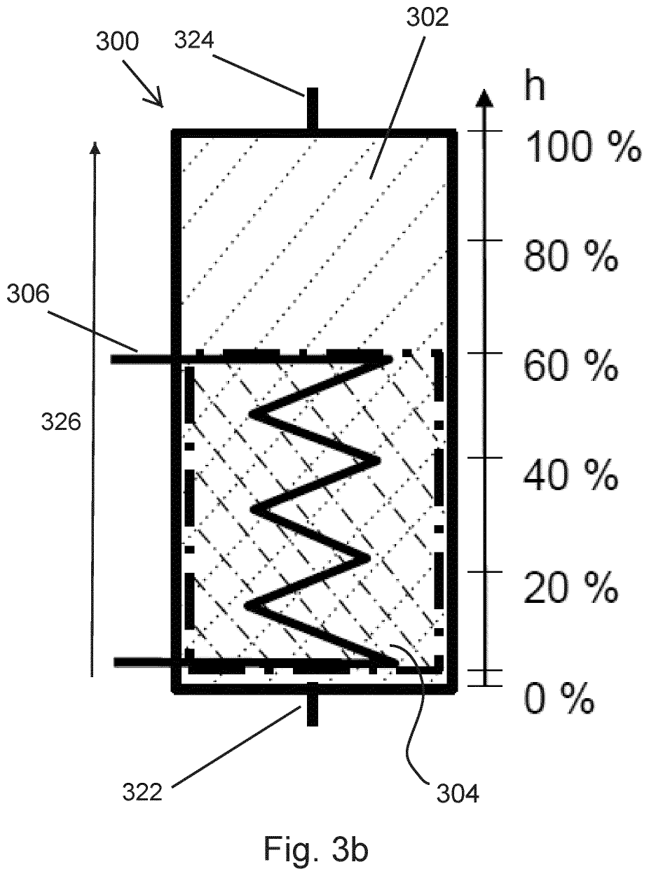

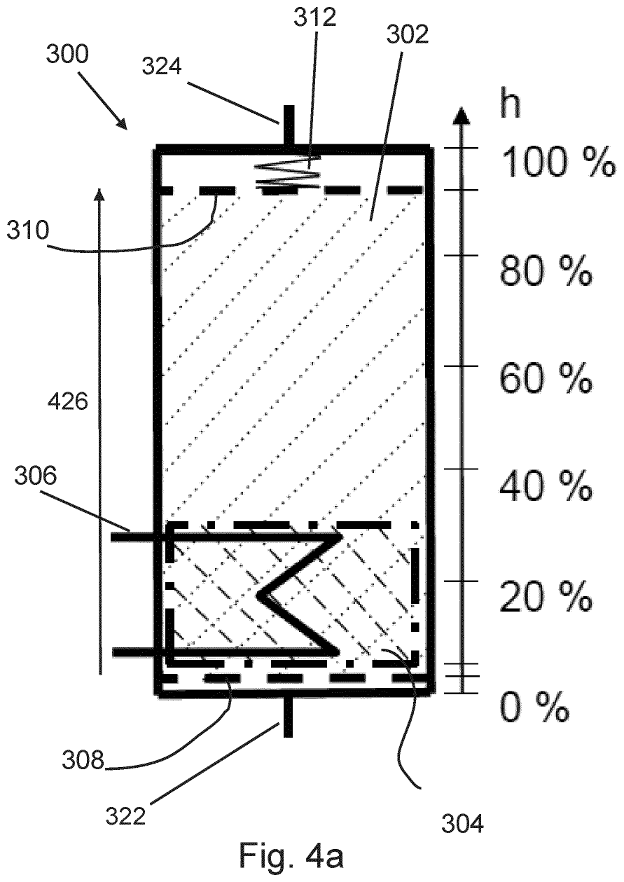

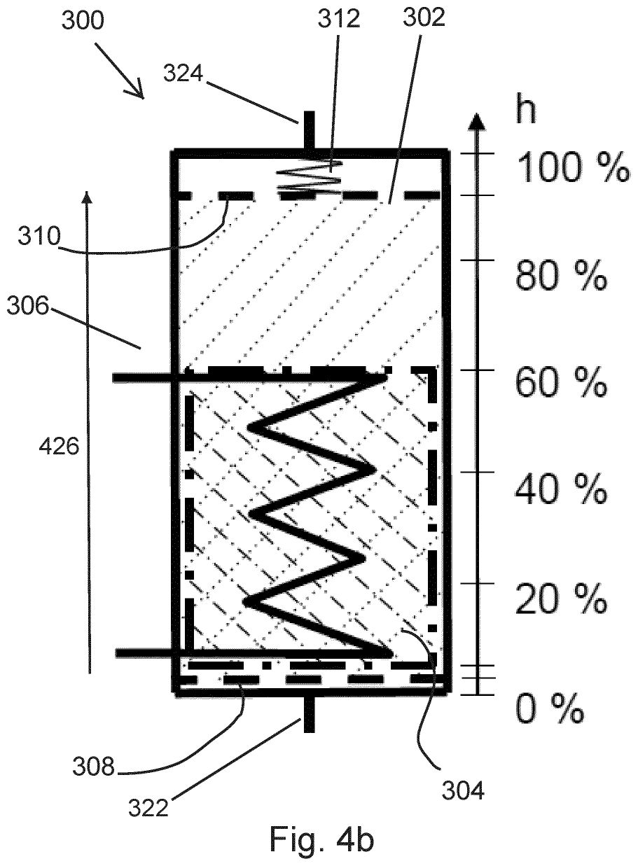

FIGS. 3a to 4b Show Different Heat Transfer Sections of a Heat Exchanger.

FIG. 1a shows a compressed gas system 100 in a schematic diagram. The compressed gas system 100 has a compressor 1 and an adsorption dryer 102. The compressor 1 inter-acts with an oil cooler 2, an oil separator vessel 3 and a compressed air cooler 4, which is described in further details below. The compressor 1 delivers compressed air to the adsorption device 102, specifically that provided between the two valves 5 and 6.

The adsorption dryer 102 has two pressure vessels 7 and 8, which can also be referred to simply as vessels. In particular, these two pressure vessels 7 and 8 operate in an alternating mode such that one operates in drying mode and the other in regeneration mode. For this purpose, by appropriate setting of valves 5 and 6, the compressed gas for drying in drying mode can be fed correspondingly to one of the two vessels 7 and 8.

Each of the two vessels 7 and 8 has an upper portion 7a/8a and a lower portion 7b/8b. Both vessels are filled with an adsorption material, which is represented as a granular material.

Each vessel 7 and 8 has a drying inlet 103/104, and a drying outlet 105/106. In the embodiment shown, the drying inlets 103 and 104 are thus at the bottom and the drying outlets 105 and 106 at the top. In drying mode, the compressed air to be dried flows from the bottom upward, and the regeneration air from the top downward.

The respective lower portion 7b/8b of the vessels 7 and 8 can be heated by means of a heater 16/17, which thus each form a heating device. If compressed air thus flows in from the drying inlet 103 or 104, it flows first through the heating region, although this is switched off in drying mode, and then through the upper portion 7a/8a. In regeneration mode, the regeneration air flows from the top downward, i.e. flows in at the drying outlet 105 or 106, flows first through the upper portion 7a/8a and then the lower portion 7b/8b which accommodates or may form the heating region. In regeneration mode, the respective heater 16/17 is in operation.

In drying mode, the dried compressed air flows either out of the drying outlet 105 or the drying outlet 106, depending on which of the two vessels 7 and 8 is being operating in drying mode, and flows essentially to the valve 12, which can also be referred to as outlet valve, and thence to the dryer exit 13, specifically to the exit from the adsorption device 102 overall. However, an auxiliary vessel containing adsorption material may also be connected in order to compensate for fluctuations in the moisture level of the dried compressed air, which is provided in one embodiment but is not shown here for simplicity.

At the same time, a portion of the dried compressed air, upstream of valve 12, is guided through restrictors 10 and 11, one or both of which lower the pressure of the dried compressed air, in particular to about ambient pressure. Which of the two restrictors 10 or 11 lowers the pressure or which lowers the pressure to what extent depends on which of the two vessels 7 and 8 is in drying mode and which is in regeneration mode. In any case, these two restrictors 10 and 11, controlled by the valve 9 arranged in between, are used to transfer a portion of the dried compressed air from the vessel being operated in drying mode to the vessel being operated in regeneration mode.

The vessel being operated in regeneration mode thus receives regeneration air at the drying outlet 105 or 106, which flows through the respective vessel 7 or 8, passing through the lower portion 7b/8b which can be regarded as the heating region, and finally flows out at the drying inlet 103 or 104. The regeneration air can thence be discharged to the environment via valve 18 or 19 and a downstream silencer 20 or 21.

One possible embodiment is thus illustrated in simplified form in FIG. 1a. The air is compressed in compressor 1. This involves injecting oil cooled in the oil cooler 2 into the compressor. The hot compressed air/oil mixture is separated in the oil separation vessel 3. The compressed air flows from the oil separation vessel through the compressed air cooler 4 and is cooled therein.

The temperature or a temperature level of the oil can likewise be increased by passing all the oil, or portions thereof, past the oil heat exchanger 2 of the compressor, in the manner of a bypass, and hence is supplied to the compressor block at higher temperature.

In the diagram shown in FIG. 1b, vessel 7 is by way of example being used for drying and vessel 8 is being regenerated. Valves 5, 9, and 19 are open and valves 6 and 18 are closed. The 3-way valve 12 connects vessel 7 to the dryer outlet 13.

The compressed air flows via valve 5 through vessel 7 and is dried therein. A large part of the water removed from the compressed air is taken up by the desiccant in the lower portion 7b of the vessel in which the heater 16 is provided. While vessel 7 is being used for drying, the heater 16 is however inactive and the dry material is accordingly not heated. The major part of the dried compressed air flows via valve 12 to the dryer outlet 13. A smaller part of the dried compressed air flows from vessel 7 via valve 9 and to vessel 8. The pressure is lowered to approximately ambient pressure by restrictors 10, 11 in order to generate the largest possible regeneration air volume. The depressurized air takes up water from the dry material in vessel 8 and exits the vessel via valve 19 and silencer 21.

The heater 17 heats the dry material in the lower portion 8b of vessel 8. In this part of the vessel, i.e. lower portion 8b, a large part of the water had been bound in the preceding drying process. The heating of the dry material boosts desorption of the water and the heating of the air allows a larger amount of water vapor per unit air mass to be transported out of the vessel. This requires a much lower amount of regeneration air than a cold regenerating adsorption dryer. As a result, the process according to FIG. 1a, b, and c is significantly more efficient than such previous processes. In FIG. 1c, in reverse operation, vessel 8 is being used for drying and vessel 7 is being regenerated.

In order to further reduce the amount of regeneration air, valve 9 can remain closed at the start of regeneration until the dry material in region 8b has been heated sufficiently by the heater 17, in order that efficient regeneration is possible from the start of supply of the regeneration air. Such operation is shown in FIG. 1d.

Compared to a standard heat-regenerating adsorption dryer, much less heat is stored in the adsorption material after regeneration, since only some of the material has been heated and, in addition, because the use of depressurized compressed air makes it possible to work at lower temperatures during regeneration.

In order to further reduce the heat stored, the heater 17 can be deactivated in the final portion of the regeneration and thus the final portion of the regeneration operated without heat supply. The mass of regeneration air used here per unit mass of heated desiccant is suitably within a range of from approx. 0.025 kg/kg to 0.22 kg/kg. Such operation is shown in FIG. 1e.

A particularly efficient embodiment that utilizes the waste heat from the compression process is shown in FIG. 2. The structure corresponds to that in FIG. 1 with a specific embodiment for the heaters 16 and 17.

Opening valves 14 or 15 allows hot oil from the compressor to flow through the heaters 16 and 17. If neither of the two heaters is active, valves 14 and 15 are closed and valve 22 is open instead.

FIG. 2b shows operation in which the vessel 7 is being used for drying and the vessel 8 is being regenerated. Thus, in this case valve 15 is open and valve 14 and valve 22 are closed.

FIG. 2c shows operation in which the vessel 8 is being used for drying and the vessel 7 is being regenerated. Here, valve 14 is open and valve 15 and valve 22 are closed.

FIG. 2d shows operation in which vessel 7 is being used for drying and vessel 8 is pre-heated at the start of regeneration. Thus, in this case valve 15 is open and valve 9 is still closed.

FIG. 2e shows operation in which vessel 7 is being used for drying and vessel 8 is not heated in the final portion of the regeneration. Thus, in this case valve 15 is closed and valve 9 is still open.

The exemplary embodiment in FIGS. 2a to 2e shows an advantageous compact combination of compressor 1 and dryer. It is however not necessary for one dryer to be directly coupled to one compressor. More particularly, it is also possible for a plurality of compressors to supply compressed air to one dryer, for one compressor to supply compressed air to a plurality of dryers, or for a plurality of compressors to supply compressed air to a plurality of dryers. It is also possible for the heat output from the compressor to be transferred to the dryer using another heat-transfer medium instead of the compressor oil. For optimization of the process, the heat-transfer medium can in addition also be heated above the temperature level at which the waste heat is available, for example with an electric heater. Further aspects or supplementary elucidations of the invention are given hereinbelow.

In the further description it is assumed that the flow through the vessels is from the bottom to the top during drying and from the top to the bottom during regeneration. Other installation positions are however also possible.

Core aspects of the invention are thus:
The method of a cold regenerating adsorption dryer is employed.
In regeneration mode heat is supplied only in the lower portion of the vessel, via a heating device.

It is advantageously possible to use existing waste heat for the heating device, for example the heat contained in the oil of a screw compressor. In water-cooled systems it is also possible to use hot water. Other heat sources that are conveniently available in the vicinity of the dryer can also be used. The process can also be carried out using an electric heater.

A reasonable proportion for the heated lower portion of the vessel the total vessel is approx. 20% to 70%.

Direct heating also offers the possibility of supplying more heat per unit amount of air than if the air were heated first and only then could the desiccant in turn be heated and the water desorbed. This reduces the amount of regeneration air required. The amount of regeneration air can be further reduced by first heating the dry material without flow through it, before the regeneration air is passed through the vessel to be regenerated.

Since dry air is used for regeneration, the temperatures required are not as high as those in dryers that regenerate with heated ambient air. This allows existing waste heat to be used at a low temperature level.

In one embodiment, the hot oil of a screw compressor with oil injection is used for heating during regeneration. This oil typically has temperatures of between 60 and 100° C.

Since the dry material is heated directly, the regeneration air is needed only for the transport of the desorbed water vapor. Lowering the pressure during regeneration allows the regeneration air volume to be further reduced. The lower the regeneration pressure, the less compressed air needs to be depressurized in order to produce the required volume flow.

FIGS. 3a, 3b, 4a, and 4b show pressure vessels having different or differently arranged heating regions. For the figures, the same reference symbols are, for better comparability, in some cases used for elements or regions that are not necessarily identical. In particular, all four figures show a pressure vessel 300 having a bed of adsorbent 302, i.e. a bed of an in particular granular adsorption material, and a heating region 304 with a symbolically depicted heat exchanger 306. The bed of adsorbent 302, i.e. the region in which it is arranged, is hatched with dotted lines. The heating region 304 is framed by a dot-dash line and in addition hatched with dot-dash lines. The heating region 304 is thus arranged within the region of the bed of adsorbent 302, which is illustrated by the superimposed hatching. As a guide to the proportions, a vessel height h is also shown in all four figures. In all four figures, a drying inlet 322 and a drying outlet 324 are also shown.

With regard to the heat exchanger 306, it should be mentioned that it is shown symbolically in the figures. It extends over the entire cross section of the bed of adsorbent 302. In particular, but not exclusively, the pressure vessel and also, accordingly, the bed of adsorbent may have a cylindrical cross section over which the heat exchanger 306 extends completely. FIGS. 3a, 3b, 4a and 4b are intended to illustrate for the heat exchanger 306 particularly different extents in the flow direction, i.e. in the direction of the height h.

The heating region 304 of the heat exchanger 306 corresponds in size approximately to a construction space of the heat exchanger 306. Adsorbent, which can also be referred to synonymously as adsorption material, is likewise present here. The heat exchanger 306 is thus surrounded by adsorbent.

There are in principle embodiments of adsorption dryers that in the pressure vessel 300 have no sieve plate, perforated plate or similar at the lower end of the pressure vessel 300. In such embodiments, the bed of adsorbent, which can also be referred to more simply as the bed, rests on the bottom of the vessel.

FIGS. 3a and 3b show such pressure vessels. In FIG. 3a the heating region 304 starts, as determined by the structural presence of the heat exchanger, only at approx. 2% of the vessel height h and extends up to approx. 30% of the vessel height h. The vessel height h is the length from the drying inlet to the drying outlet.

In FIG. 3b the heating region 304 starts, as determined by the structural presence of the heat exchanger, only at approx. 2% of the vessel height h and extends up to approx. 60% of the vessel height h. In FIGS. 3a and 3b, a drying zone 326 extends over the entire height h. The drying zone is here illustrated only by an arrow showing the length of the drying zone. The drying zone does in fact of course extend within the pressure vessel 300, specifically within the bed of adsorbent 302. The same applies to a drying zone 426 in FIGS. 4a and 4b, which is further elucidated hereinbelow The region of the bed of adsorbent 302 essentially defines the drying zone 326/426.

In addition, there are embodiments of adsorption dryers that have a sieve plate, perforated plate or similar in the lower region of the pressure vessel, which is referred to here as an offset bottom section 308. This offset bottom section is spaced slightly apart from the bottom of the pressure vessel and has a perforation that is sufficiently small that the adsorbent granules do not pass through, but the process air does. The bed of adsorbent thus rests on the offset bottom section 308, which can be for example a sieve plate. This means that, after flowing in from below, the process air is able to spread throughout the space below the offset floor section 308 before flowing upward through the bed. If condensate/liquid water is entering at the bottom of the vessel with the compressed air when there has been less than 100% separation of condensate after the heat exchanger, it is advantageous when this can collect on the vessel bottom beneath the sieve plate. The adsorbent is then not lying in “liquid water”.

Such embodiments with offset bottom section 308 are shown in FIGS. 4a and 4b. The drying zone 426 in FIGS. 4a and 4b consequently does not extend over the entire height h.

FIG. 4a shows a pressure vessel 300 with offset bottom section 308 that can be designed as a sieve plate or perforated plate, the offset bottom section 308 being located at approx. 3% of the vessel height h. The heating region 304 starts, as determined by the structural presence of the heat exchanger, only at approx. 5% of the vessel height h and extends up to approx. 30% of the vessel height h.

Pressure may be exerted on the bed from above by means of, for example, a perforated plate 310 having, for example, a compression spring 312, in order that, when there is a change in the direction of flow of compressed gas, i.e. when there is a flow reversal, this does not result in movement or swirling of the granules. This protects the granules against mechanical wear. The granules in this case extend as far as approx. 92% of the vessel height h.

FIG. 4b shows a pressure vessel 300 with offset bottom section 308 that can be designed as a sieve plate or perforated plate, the offset bottom section 308 being located at approx. 3% of the vessel height h. The heating region 304 starts, as determined by the structural presence of the heat exchanger, only at approx. 5% of the vessel height h and extends up to approx. 60% of the vessel height h.

Here too, pressure may be exerted on the bed from above by means of, for example, a perforated plate 310 having, for example, a compression spring 312, in order that, when there is a change in the direction of flow of compressed gas, i.e. when there is a flow reversal, this does not result in movement or swirling of the granules. This protects the granules against mechanical wear. The granules in this case extend as far as approx. 92% of the vessel height h.

1. A method for drying a compressed gas, using an adsorption dryer, the adsorption dryer includes at least one pressure vessel containing an adsorption material for adsorbing moisture from the compressed gas, the method comprising:
drying the compressed gas during a drying mode, during the drying mode the compressed gas flows from a drying inlet through a drying zone to a drying outlet, passing through the pressure vessel along the adsorption material, and exiting as a dried compressed gas,
regenerating the adsorption material during a regeneration mode, during the regeneration mode a regeneration gas flows from the drying outlet through the drying zone to the drying inlet, passing through the pressure vessel along the adsorption material, and in doing so draws moisture out of the adsorption material, and
in regeneration mode there is partial heating in a heating region in the pressure vessel, wherein
the heating region is arranged only in a subregion of the pressure vessel adjoining the drying inlet.

2. The method of claim 1, wherein
the heating region is arranged in a section of from 0% to 80%, of the drying zone, measured from the drying inlet to the drying outlet, and/or
the heating region extends over at least 20% of the drying zone, and wherein
there is no heating outside the heating region, or reduced heating with less than 30% energy input per unit volume compared to the heating region.

3. The method of claim 2, wherein
a compressed gas fraction, comprising a portion of the dried compressed gas is used as regeneration gas,
the compressed gas fraction is admitted into the pressure vessel at the drying outlet, and wherein
the compressed gas fraction undergoes a reduction in pressure during or before admission into the pressure vessel.

4. The method of claim 1 wherein
heating in the pressure vessel is effected by means of a heat exchanger, and wherein
heat transfer sections of the heat exchanger are surrounded by the adsorption material so as to release heat to the adsorption material.

5. The method of claim 1 wherein
the compressed gas is generated by a pressure generating device, and
waste heat of the pressure generating device is used for heating the heating region during regeneration, and wherein
heated oil from a screw compressor with oil injection is used to heat the heating region during regeneration.

6. The method of claim 5, wherein
the heating region is heated using
waste heat of the pressure generating device and
active heating from an energy source, such that
the active heating further raises a temperature of a heating medium heated from the waste heat to a predetermined temperature.

7. The method of claim 1 wherein
at least two pressure vessels are used, in a combined operation, at least one of the two pressure vessels operates in the drying mode while another operates in the regeneration mode, and
the pressure vessel operating in the drying mode outputs dried compressed gas, a portion of which is diverted as a compressed gas fraction and supplied to the pressure vessel operating in the regeneration mode and is used as regeneration gas.

8. The method of claim 1 wherein,
when switching over from the drying mode to the regeneration mode,
the flow of the compressed gas from the drying inlet to the drying outlet is initially paused,
then the heating of the heating region is started, and
after starting heating, a predeterminable heating time is observed before allowing the regeneration gas into the pressure vessel.

9. The method of claim 1 wherein,
when switching over from the regeneration mode to the drying mode,
heating is initially stopped, and
after stopping the heating, a predeterminable cooling time is observed before allowing the compressed gas into the pressure vessel, and wherein
after stopping heating, regeneration gas continues to flow through the pressure vessel for part or all of the cooling time.

10. The method of claim 1 wherein
compressed air is dried as the compressed gas, and wherein
a portion of the dried compressed air is used for the regeneration gas, so that
regeneration air is used as the regeneration gas, and wherein after flowing through the drying zone, the regeneration air flows out into an environment of the adsorption dryer.

11. The method of claim 1 wherein
in the regeneration mode, a pressure in the pressure vessel is lowered to below a pressure outside the pressure vessel,

12. The method of claim 1 wherein
dried compressed air after flowing out of the drying outlet flows through an auxiliary pressure vessel containing an adsorption material, the auxiliary pressure vessel not being integrated into the regeneration mode.

13. An adsorption dryer for drying a compressed gas, the adsorption dryer comprising: at least one pressure vessel including an adsorption material for adsorbing moisture from the compressed gas, the dryer being primed to carry out a process in which
in a drying mode for drying the compressed gas, the compressed gas flows from a drying inlet through a drying zone to a drying outlet, passing through the pressure vessel along the adsorption material, and exiting as a dried compressed gas, and
in a regeneration mode for regenerating the adsorption material, a regeneration gas flows from the drying outlet through the drying zone to the drying inlet, passing through the pressure vessel along the adsorption material, and in doing so drawing moisture out of the adsorption material, wherein
in the regeneration mode, there is partial heating in a heating region in the pressure vessel, and wherein
the heating region is arranged only in a subregion of the pressure vessel adjoining the drying inlet.

14. The adsorption dryer of claim 13, wherein
the heating region is arranged in a section of from 0% to 80%, of the drying zone measured from the drying inlet to the drying outlet,
and extends over at least 20% of the drying zone, and wherein
a heat exchanger is provided for heating in the pressure vessel that
comprises heat transfer sections arranged in the heating region that are surrounded by the adsorption material.

15. The adsorption dryer of claim 14 wherein
at least two pressure vessels are provided and
the adsorption dryer is primed for a combined operation in which at least one of the two pressure vessels operates in the drying mode while another operates in the regeneration mode, and wherein
the two pressure vessels are connected with one another such that their combined effect is that the pressure vessel operating in the drying mode outputs dried compressed gas, a portion of which is diverted as a compressed gas fraction and supplied to the pressure vessel operating in the regeneration mode and used as regeneration gas, and wherein
an auxiliary pressure vessel containing an adsorption material is provided, the auxiliary pressure vessel being connected to the pressure vessel operating in the drying mode such that it is not integrated into the regeneration mode.

16. A compressed gas system for providing dried compressed gas, the compressed gas system comprising:
a compressor for compressing gas into a compressed gas,
an adsorption dryer including a plurality of pressure vessels filled with an adsorption material, the pressure vessels each having
a drying zone for drying the compressed gas, and
a heating region that extends over a portion of the drying zone, wherein a heat exchanger is provided and configured to heating the heating region, the heat exchange being connected to the compressor so as to heat the heating region with waste heat from the compressor.
